(19) United States
(12) Patent Application Publication
(10) Pub. No.: US 2011/0017866 A1
(43) Pub. Date: Jan. 27, 2011

(54) LOCKING DEVICE

(75) Inventors: Pascal-Marie Paul Marcel Soulier, Le Havre (FR); Aurélie De Sorbay, Le Havre (FR)

Correspondence Address: CANTOR COLBURN LLP, 20 Church Street, 22nd Floor, Hartford, CT, 06103, US

(73) Assignee: AIRCELLE, GONFREVILLE L'ORCHER (FR)

(21) Appl. No.: 12/673,672

(22) PCT Filed: Jun. 12, 2008
(86) PCT No.: PCT/FR08/00808

§ 371 Date: Feb. 16, 2010

(30) Foreign Application Priority Data
Aug. 20, 2007 (FR) 07/05919

(51) Int. Cl. B64D 29/00; B64C 1/16

(52) U.S. Cl. 244/54; 403/24

(57) ABSTRACT

The invention relates to a locking device (11) comprising at least one locking system (13) having at least one locking member (17) that can be actuated by linking means (28), the linking means being able to be moved over a defined travel, the movement of the locking means (28) over a first part of the travel enabling the locking member (17) to be actuated, alternately between an unlocked position of the locking member (17) and a locked position thereof, characterized in that the locking system (13) is designed so that the locking member (17) remains immobile during the movement of the linking means (28) over a second portion of the travel, with a view to compensating for the adjustment of the connecting means (28) and also any malpositioning of the locking system (13).

### TECHNICAL FIELD

The invention relates to a locking device comprising at least one locking system comprising at least one locking member actuable by connection means, the connection means being displaceable over a specific travel, the displacement of the connection means over a first part of the travel making it possible to actuate the locking member alternately between a position for unlocking the locking member and a position for locking the latter.

### BACKGROUND

A locking device of this type is used, in particular, in order to equip a nacelle, itself intended for equipping an aircraft.

An aircraft is driven by means of a plurality of turbojet engines, each accommodated in a nacelle which likewise houses an assembly of accessory actuating devices associated with its operation and ensuring various functions when the turbojet engine is in operation or is at a standstill. These accessory actuating devices comprise, in particular, a mechanical system for the actuation of thrust reversers.

A nacelle generally has a tubular structure comprising an air inlet upstream of the turbojet engine, a middle section intended for surrounding a blower of the turbojet engine, a rear section capable of housing thrust reversal means and intended for surrounding the combustion chamber of the turbojet engine, and generally terminates in an ejection nozzle, the outlet of which is located downstream of the turbojet engine.

Modern nacelles are often intended for housing a double-flow turbojet engine capable of generating, by means of the rotating blades of the blower, a stream of hot air (also called a primary stream) coming from the combustion chamber of the turbojet engine.

A nacelle generally has an external structure, called an Outer Fixed Structure (OFS), which, with a concentric internal structure, called an Inner Fixed Structure (IFS), defines an annular flow channel, also called a flow section, aiming at channeling a stream of cold air, called a secondary stream, which circulates outside the turbojet engine. The primary and secondary streams are ejected from the turbojet engine at the rear of the nacelle.

Each propulsive assembly of the aircraft is thus formed by a nacelle and a turbojet engine and is suspended on a fixed structure of the aircraft, for example under a wing or on the fuselage, by means of a pylon or mast attached to the turbojet engine or to the nacelle.

The rear section of the external structure of the nacelle is conventionally formed from a first and a second half-shell of substantially semi-cylindrical shape, on either side of a longitudinal vertical plane of symmetry of the nacelle, and mounted movably so as to be capable of being deployed between an operating position and a maintenance position for the purpose of giving access to the turbojet engine. The two half-shells are generally mounted pivotably about a longitudinal axis forming a hinge in the upper part (at 12 o'clock) of the reverser. The half-shells are held in the closing position by means of locking devices which are arranged at least along a junction line located in the lower part (at 6 o'clock) and the control of which is accessible by the operator in the lower part.

The locking device of the abovementioned type has the disadvantages set out below.

In order to ensure that the locking device functions properly, it is necessary to set the position of the connection means exactly by means of a setting system. Such a setting makes it possible to compensate the positioning faults between the various components, to avoid the effects of thermal expansion and to allow for the manufacturing tolerances of each component.

To be precise, in the event of poor positioning, it may happen that the locking system is not completely unlocked or locked, this being detrimental in terms of safety.

Moreover, in such a case, the operator will tend to exert force on the connection means so as to subject them to compressive or tensile stress.

It is then necessary, in addition to the lengthy setting which is a possible source of operator errors, to overdimension the connection means so that they are not damaged by such stresses.

### BRIEF SUMMARY

The disclosure provides a locking device making it possible to avoid an exact setting of the connection means and an over dimensioning of these.

To achieve this, the invention relates to a locking device of the abovementioned type, characterized in that the locking system is designed in such a way that the locking member remains immobile during the displacement of the connection means over a second part of the travel, for the purpose of compensating the setting of the connection means and the positioning faults of the locking system.

Thus, only the first part of the travel makes it possible to lock or unlock the locking member. The second part of the travel makes it possible to compensate any offset of the connection means, so as to ensure that, when the connection means have been displaced over their entire travel by the operator, the locking system is effectively locked or unlocked. Thus, it is possible to dispense with setting the connection means. Moreover, the latter are not therefore subjected to high stresses by the operator for the purpose of correctly locking or unlocking the locking system.

According to one possibility of the invention, the locking member is a bolt.

According to one characteristic of the invention, the device comprises transmission means linking the connection means to the bolt, the transmission means comprising a track having at least one active part and at least one passive part, the connection means comprising a follower element which is displaced along the track, the transmission means being designed in such a way that the bolt is actuated or remains immobile during the displacement of the follower element along the active part or the passive part of the track respectively.

Thus, a poor positioning of the follower element with respect to the track has no effect on the actuation of the bolt. To be precise, the displacement of the connection means over their entire travel ensures that the follower element has been displaced along the active part of the track and that, consequently, the bolt has been effectively actuated, this being achieved even if there is a positioning fault of the follower element with respect to the track.

Advantageously, the track comprises a first and a second passive part arranged on either side of the active part.

According to one possibility of the invention, the transmission means comprise a cam linking the bolt to the connection means, the cam being designed to be driven in rotation during the displacement of the connection means over only the first part of the travel, the cam being designed in such a way that its rotation brings about the actuation of the bolt.

According to one embodiment of the invention, the connection means comprise a first end linked to the transmission means and a second end linked to an actuating handle.

According to another embodiment of the invention, the connection means comprise a first end linked to the transmission means and a second end linked to an additional locking system, the actuation of the additional locking system bringing about the displacement of the connection means.

The invention relates, moreover, to a turbojet engine nacelle intended for equipping an aircraft and comprising a front air inlet section, a middle section intended for surrounding a blower of the turbojet engine, and a rear section formed from at least one first and one second half-shell which are mounted movably in terms of rotation on an axis, so as each to be capable of being deployed between an operating position, in which the half-shells are close to one another, and a maintenance position, in which the half-shells are apart from one another, characterized in that it comprises at least one locking device according to the invention.

The invention also relates to an aircraft equipped with at least one nacelle according to the invention.

### BRIEF DESCRIPTION OF THE DRAWINGS

In any event, the invention will be understood clearly from the following description, with reference to the accompanying diagrammatic drawing illustrating two embodiments of this locking device by way of example.

FIG. 1 is a diagrammatic view of a nacelle in longitudinal section;

FIG. 2 is an exploded view of the rear section of the nacelle in perspective;

FIGS. 3 and 4 are front views of the locking system in the locking position and in the unlocking position respectively.

### DETAILED DESCRIPTION

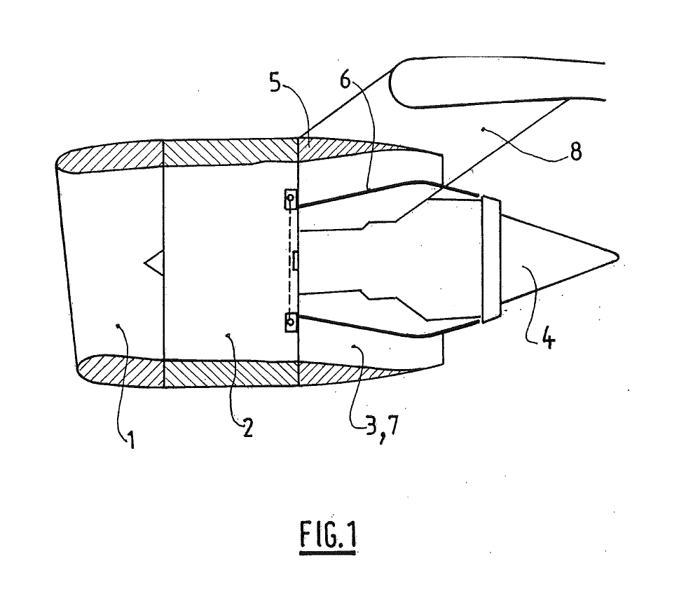

FIG. 1 illustrates a nacelle according to the invention intended for equipping an aircraft. This nacelle has a tubular structure comprising an air inlet 1 upstream of the turbojet engine, a middle section 2 intended for surrounding a blower of the turbojet engine, a rear section 3 capable of housing thrust reversal means and intended for surrounding the combustion chamber of the turbojet engine, and terminates in an ejection nozzle 4, the outlet of which is located downstream of the turbojet engine.

The nacelle is intended for housing a double-flow turbojet engine capable of generating, by means of the rotating blades of the blower, a stream of hot air (also called a primary stream) coming from the combustion chamber of the turbojet engine.

The nacelle has an external structure 5, called an Outer Fixed Structure (OFS), which, with a concentric internal structure 6, called an Inner Fixed Structure (IFS), defines an annular flow channel 7, also called a flow section, aiming at channeling a stream of cold air, called a secondary stream, which circulates outside the turbojet engine. The primary and secondary streams are ejected from the turbojet engine at the rear of the nacelle.

Each propulsive assembly of the aircraft is thus formed by a nacelle and a turbojet engine and is suspended on a fixed structure of the aircraft, for example under a wing or on the fuselage, by means of a pylon or mast 8 attached to the turbojet engine or to the nacelle.

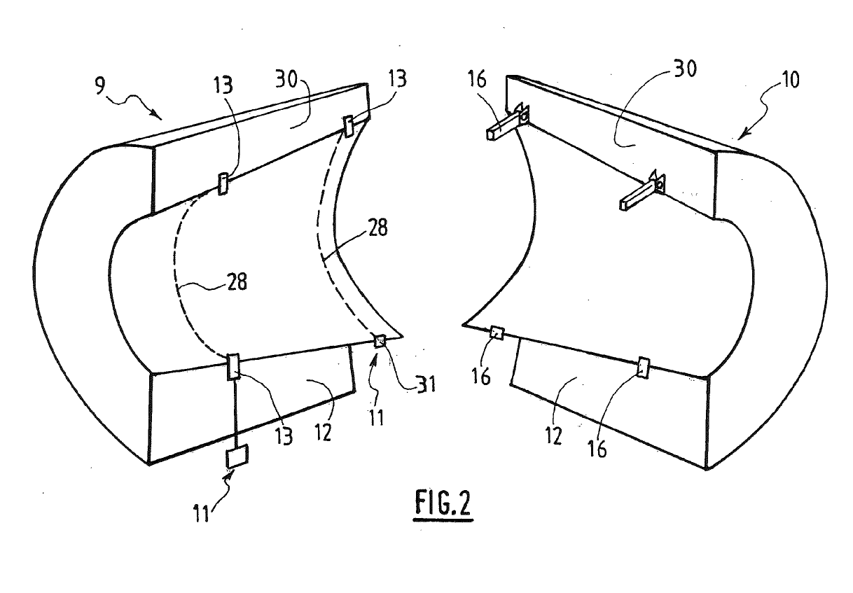

As may be gathered from FIG. 2, the rear section 3 of the external structure of the nacelle is formed from a first and a second half-shell 9, 10 of substantially semi-cylindrical shape, on either side of a longitudinal vertical plane of symmetry of the nacelle, and mounted movably so as to be capable of being deployed between an operating position and a maintenance position for the purpose of giving access to the turbojet engine. The two half-shells 9, 10 are each mounted pivotably about an axis forming a hinge in the upper part (at 12 o'clock) of the reverser. The half-shells 9, 10 are held in the closing position by means of locking devices 11 arranged along a junction line 12 located in the lower part (at 6 o'clock). For the sake of clarity in the drawing, only some of the locking devices 11 have been illustrated.

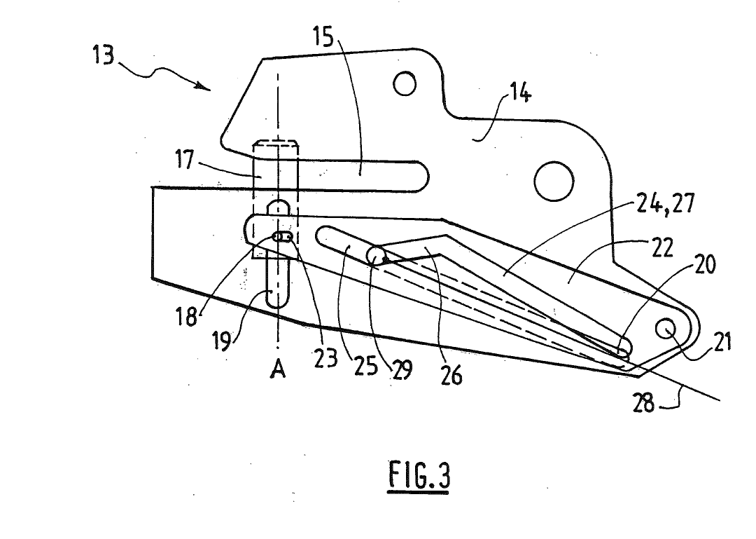

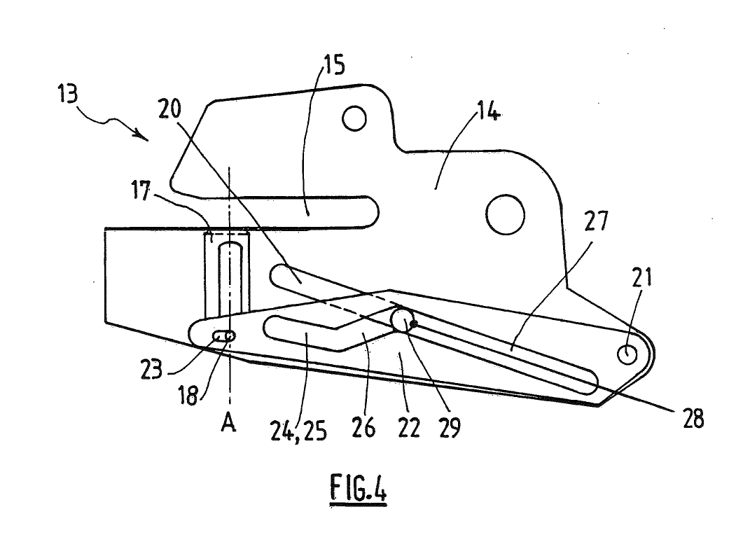

As is illustrated more particularly in FIGS. 3 and 4, the locking device 11 comprises a locking system 13 comprising a body 14 which is fixed with respect to the first half-shell 9 of the nacelle.

The body 14 comprises a slot 15 making it possible to insert a retaining member 16 secured to the second half-shell, as illustrated in FIG. 2.

A bolt 17 is mounted on the body 14 so as to be displaceable in translational motion along an axis A perpendicular to the slot 15 between a locking position, in which the bolt 17 passes through the slot or projects into the latter, as illustrated in FIG. 3, and an unlocking position, in which the bolt 17 is accommodated completely within the body 14 and does not project into the slot 15, as illustrated in FIG. 4.

The bolt 17 comprises a stud 18 projecting perpendicularly to the axis A and to the slot 15 through an oblong aperture 19 formed in the body 14 along the axis A, so as to allow the displacement of the bolt 17. According to one embodiment, the bolt comprises two studs 18 radially opposed and extending on either side of the bolt 17 through corresponding apertures 19.

Furthermore, the body 14 comprises an oblong orifice or groove 20 extending obliquely with respect to the slot 15 and to the oblong aperture 19 between a first end located in the vicinity of the slot 15 and of the oblong aperture 19 and a second end located in the vicinity of an axis of articulation 21, the function of which is described below.

The locking device 13 comprises, furthermore, a cam 22 of elongate shape comprising a first and a second end. The cam is mounted pivotably in the region of its first end on the body 14 of the locking system 13 about the axis 21. The cam 22 comprises, moreover, an oblong hole 23 in the region of its second end, the stud 18 of the bolt 17 projecting into the oblong hole 23. More specifically, the oblong hole 23 extends along an axis substantially perpendicular to the axis A of displacement of the bolt 17.

The cam 22 comprises, moreover, a track 24 formed by an oblong aperture in the general form of a staircase step. The track thus has three successive parts, namely a first passive part 25, a second active part 26 and a third passive part 27, the function of which is described in detail below.

The locking device likewise comprises a cable 28, illustrated diagrammatically by a line, comprising a first actuating end. The cable 28 comprises, furthermore, a finger 29 in the region of its second end, the finger 29 being inserted into the track 24 of the cam 22 and into the groove 20 of the body 14, so as to form a follower element. The cable 28 extends, in the region of its second end, substantially along the axis of the groove 20, so that said cable is not subjected to any bending stress, but only to tensile and compressive stresses, so that the dimensioning of the cable can be reduced.

According to the alternative embodiment under consideration, the first actuating end of the cable 28 is attached to a handle or to another conventional locking system or one equipped with a bolt.

The functioning of the locking device will now be described in more detail.

When the operator wants to unlock the locking system 13, he exerts a pull on the cable 28 by means of a control accessible at 6 o'clock, so that the follower finger 29 is displaced along the first passive part 25 of the track 24.

The first passive part 25 extends parallel to the axis of the groove 20 in the locking position of the bolt 17, as illustrated in FIG. 3, so that, during the displacement of the follower finger 29 along the first passive part 25, the bolt 17 remains immobile and ensures the locking of the locking means 23.

The follower finger 29 subsequently passes along the second active part 26 of the track 24. The latter extends obliquely with respect to the groove 20, so that the displacement of the follower finger 29 causes the pivoting of the cam 22 counterclockwise about the axis 21, thus simultaneously bringing about the downward displacement of the bolt 17.

During this displacement, the stud 18 of the bolt 17 undergoes translational movement in the oblong hole 23 of the cam 22, thus making it possible to compensate the path deviations between the curved path of the end of the cam 22 attached to the bolt 17 and the straight path A of the latter.

When the operator continues to exert a pull on the cable 28, the follower finger 29 is then displaced along the third passive part 27 of the cam 22, then extending along the groove 20, so that the bolt 17 remains immobile and ensures the locking of the locking means 23.

The locking of the locking system 13 is obtained by means of the reverse sequence of the abovementioned steps.

According to one embodiment of the invention, the actuating end is equipped with an actuating handle.

According to another embodiment of the invention, illustrated in FIG. 2, the locking system 13 is arranged in an upper junction zone 30 (12 o'clock), the cable 28 connecting the locking system 13 to an additional locking system 31 arranged in the region of the lower junction zone 12. The additional locking system 31 is designed for carrying out the displacement of the cable 28 when the latter is actuated by the operator.

Whatever the alternative embodiment under consideration, the locking device 11 makes it possible to avoid an exact setting, even to avoid any setting of the position of the follower finger 29 in the track 24. To be precise, the exact position of the follower finger 29 is unimportant since the latter necessarily passes along the active part 26 of the track 24, so that the complete locking or unlocking of the locking system 13 is ensured. Furthermore, the presence of the passive parts 25, 27 makes it possible to ensure that the follower finger 29 does not come into abutment against one of the ends of the track 24, thus preventing the operator from inadvertently subjecting the cable 28 to stress.

It will be appreciated that the invention is not limited only to the embodiments of this locking device which are described above by way of example, but, on the contrary, embraces all its variants.

1. A locking device comprising at least one locking system comprising at least one locking member actuable by connection means, the connection means being displaceable over a specific travel, the displacement of the connection means over a first part of the travel making it possible to actuate the locking member alternately between a position for unlocking the locking member and a position for locking the latter, wherein the locking system is designed in such a way that the locking member remains immobile during the displacement of the connection means over a second part of the travel, for the purpose of compensating a setting of the connection means and positioning faults of the locking system, the device comprising, furthermore, transmission means linking the connection means to the bolt, the transmission means comprising a track having at least one active part and at least one passive part, the connection means comprising a follower element which is displaced along the track, the transmission means being designed in such a way that the bolt is actuated or remains immobile during the displacement of the follower element along the active part or the passive part of the track respectively.

2. The device as claimed in claim 1, wherein the locking member is a bolt.

3. The device as claimed in claim 1, wherein the track comprises a first and a second passive part arranged on either side of the active part.

4. The device as claimed in claim 1, wherein the transmission means comprise a cam linking the bolt to the connection means, the cam being designed to be driven in rotation during the displacement of the connection means over only the first part of the travel, the cam being designed in such a way that rotation brings about actuation of the bolt.

5. The device as claimed in one of claims 1 to 4 claim 1, wherein the connection means comprise a first end linked to the transmission means and a second end linked to an actuating handle.

6. The device as claimed in claim 1, wherein the connection means comprise a first end linked to the transmission means and a second end linked to an additional locking system, the actuation of the additional locking system bringing about displacement of the connection means.

7. A turbojet engine nacelle intended for equipping an aircraft and comprising a front air inlet section, a middle section intended for surrounding a blower of the turbojet engine, and a rear section formed from at least one first and one second half-shell which are mounted movably in terms of rotation on an axis, so as each to be capable of being deployed between an operating position, in which the half-shells are close to one another, and a maintenance position, in which the half-shells are apart from one another, the turbojet engine nacelle further comprising at least one locking device as claimed in claim 1.

8. An aircraft, wherein it is equipped with at least one nacelle as claimed in claim 7.
